(19) United States
(12) Patent Application Publication
(10) Pub. No.: US 2023/0254400 A1
(43) Pub. Date: Aug. 10, 2023

(54) Accessing real-time wearable recording devices and/or body-camera video and audio in two-way communication with the wearer.

(71) Applicant: Neal Hamza, Clearwater, FL (US)

(72) Inventor: Neal Hamza, Clearwater, FL (US)

(73) Assignee: Neal Hamza, Clearwater, FL (US)

(21) Appl. No.: 18/166,283

(22) Filed: Feb. 8, 2023

(51) Int. Cl. H04M 1/72421; G08B 25/10; G06V 40/50; G06V 40/16; G06V 10/26; H04M 1/72445; H04L 51/18; H04L 65/80; H04L 65/613; H04N 7/18

(52) U.S. Cl. CPC H04M 1/72421; G08B 25/10; G06V 40/50; G06V 40/172; G06V 10/273; H04M 1/72445; H04L 51/18; H04L 65/80; H04L 65/613; H04N 7/185

(57) ABSTRACT

A method of accessing real-time body-camera/wearable recording device video/footage and audio in two-way communication with the wearer. The technologies herein will also describe a method of transferring/synchronizing the data on the camera flash storage to a cloud storage account. The data in the cloud storage account can be accessed by departmental heads and viewed in relatively close sequence of the original capture thereof. This will safeguard against any data destruction on the physical camera storage, the potentiality of the device being stolen, lost, or intentional deletes, etc. Subsequently, the technologies herein can be used to triangulate the device(s) location via pings (5G cellular service) and/or satellite positioning. The technologies herein can be adapted to automated surveillance drones, remotely controlled drones, and/or robotic drones in the personification of humans/animals, nontraditional/traditional forms or a variant thereof.

### REFERENCES

This patent application claims the benefit of U.S. patent application Ser. No. 18/166,283 (utility non-provisional patent submitted Feb. 8, 2023 at 4:27:04 PM ET); 29/870,992 (design non-provisional patent submitted Feb. 9, 2023 at 7:19:37 PM ET); and 63/487,696 (utility provisional patent submitted Mar. 1, 2023 at 2:24:22 PM ET); entitled “Accessing real-time wearable recording devices and/or body-camera video and audio in two-way communication with the wearer,” which is hereby incorporated by reference in its entirety.

With no claims to the following product listed in 0001, at present, the Apple iPhone 14 Pro has partial communication to satellites for, “Emergency SOS”, https://www.apple.com/iphone-14-pro/specs/ (retrieved Jan. 30, 2023).

With no claims to the following products listed in 0002, additional devices with similar functionality to the personifications contained herein are, wired Arlo, Nest, and Ring doorbells for home/commercial utilization, the smartphone installable apps enable two-way, real-time communication and/or streaming of high-resolution videos and/or images. Some are also equipped with facial recognition.

### FEDERALLY SPONSORED RESEARCH AND DEVELOPMENT

Zero governmental, entities, and/or agencies sponsored this research/development. The idea is solely that of Neal Hamza, '80 and his alone.

### JOINT RESEARCH AGREEMENT

Zero research agreements in conjunction with any governmental body, entities, agencies, and/or persons.

### REFERENCE TO A “SEQUENCE LISTING”, A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

All data pertinent to said patent is contained herein.

### PRIOR ART

A Google image of Tyre Nichols being assaulted (Memphis, Tenn., January 2023)—captured from a pole-mounted street camera. For the sake of illustration as to what the live stream/footage personified in this technology can capture and how ops-center/dispatch and/or leadership can intervene before it gets out of hand.

Google images of a map.

Google images of a satellite and 5G cellular tower.

### BACKGROUND OF THE INVENTION

Body-cameras and/or other wearable recording devices are routinely used. Historically the data/recordings are only viewable after the fact and ops-center/dispatch and/or other leadership are not able to interact with real-time images/video, or see the occurrence in real-time, and having the data only accessible after the fact. They are used in an array of situations, ranging from, but not limited to, surveillance, traffic stops, special operations/tactical events, historical accounts of incidents and/or procedural audits and as it relates to this invention, it will now have the ability to stream/be viewed in real-time and output audible voice communication to the wearer, by ops-center/dispatch and/or leadership.

### SUMMARY OF THE INVENTION

In this personification, the body-camera/wearable recording device is equipped with a speaker for real-time sound output purposes, satellite chip and a 5G cellular chip. In this personification ops-center/dispatch will be able to interact with the wearer via speech, the wearer will also be able to interact verbally with the ops-center/dispatch via speech through the integrated microphone on the body-camera/wearable recording device, or to anyone with access to the downloadable/installable app. and/or access to the website/portal with rights to each wearable recording device/body-camera. In so doing, ops-center/dispatch can view incidents in real-time, via high-resolution streaming video/audio, enabling them to engage EMS/EMTs in a prompt timeframe if warranted, they will be able to gauge whether additional backup units are needed, leadership can be sent a link to click on, via encrypted SMS/Email and view the live feed/stream of an in-progress situation, arrest and/or operation, they can interact with their subordinates in real-time instructing them to standdown, change tactical positioning, and to cease any potential activities that could be harmful to a civilian or target and/or to themselves. This will provide real-time accountability and informed decision making, as to minimize loss of life, both for civilians and the wearer of said wearable recording device/body-camera(s).

### BRIEF DESCRIPTION OF DRAWINGS

FIG. 1, in this exemplary personification, the body-camera/wearable recording device is depicted with the layers of its components, integrated satellite chip, integrated 5G cellular chip, the integrated microphone/speaker for input/output verbal communication, integrated processor, system board, integrated battery, integrated flash storage, integrated RAM, physical charging ports/docking points, and the lens.

FIG. 2, in this exemplary personification, it depicts the flow of data/connectivity to the satellite/5G cellular towers enabling voice communication, the streaming of high-resolution video/voice and subsequently the synchronizing of videos/data to a cloud storage account.

FIG. 3, in this exemplary personification, it illustrates the type of computer that an ops-center/dispatch would readily use to access the body-camera/wearable recording device. Each user will have their own unique account such as an AD/AAD account for security and audit purposes. Once logged-in to the site/portal/installable app, it will depict all the body-camera/wearable recording devices. Illustrated on the left quadrant of the screen there are three body-cameras/wearable recording devices, 204/Smith, 666/Lewis, and 507/Jones. The number in the body-camera/wearable recording device denotes the hardcoded numbers (it can be a hexadecimal number; i.e., AA0351, BC1191, etc.) of said body-camera/wearable recording device, it is integrated on the firmware chip and cannot be changed, the name section denotes the wearer, who checked it out at the start of their shift. You will click on a body-camera/wearable recording device to enter it, on the right quadrant of the screen, it illustrates the status of the body-camera/wearable recording device, “power on”, the “battery percentage,” the wearer it is attached to during the operation/shift (666/Lewis), the “wakeup” icon that can be used to send a “wakeup command/power on” signal to the body-camera/wearable recording device if it is off and has some sort of battery power/trickle charge left, the satellite and 5G data connection feature checked (for communication and data sync to the cloud), the icon to “stream” real-time footage of said wearer at the time, and the icon for a “map view” of the body-camera/wearable recording device(s), as illustrated in FIG. 4 and FIG. 5.

FIG. 4, in this exemplary personification, it illustrates a satellite in orbit triangulating the positions of the body-camera/wearable recording device in real-time, 204/Smith, 507/Jones, and 666/Lewis.

FIG. 5, in this exemplary personification, it illustrates 5G cellular towers pinging a body-camera/wearable recording device, 666/Lewis.

FIG. 6, in this exemplary personification, it illustrates someone in the ops-center/dispatch who has clicked on the “stream” icon of the body-camera/wearable recording device for, 666/Lewis, (before they can proceed to the live stream, they will be prompted to enter a personalized pin, which will be there for an added layer of security and for audit purposes). Here it will display a “live stream in progress,” the URL/link to the body-camera/wearable recording device/live stream, it will give the person viewing the live stream the ability to “mute” their microphone as to minimize any feedback or background noise from the ops-center/dispatch coming across to the wearer. The person in the ops-center/dispatch viewing the live stream of said body-camera/wearable recording device will have the ability to click on the “map view” icon, and that will open another page for said person to see the map view of this body-camera/wearable recording device and other body-camera/wearable recording devices in relation to it. They can be color coded red for if a unit is busy/in an active situation, or green if they are free as to render aid to other units. Here it will also give the person in the ops-center/dispatch the ability to click on the “send link” icon, this will open a new email with the URL/link to the body-camera/wearable recording device's live stream. At which the user can send it to someone in leadership by email or to a smartphone via SMS.

FIG. 7 and FIG. 8, in these exemplary personifications, it illustrates the types of mobile devices (smart tablets and/or handled/smartphones) that can access the live footage/real-time video and audio in two-way communication with the wearer via an installable app on said tablet/smartphone.

FIG. 9, in this exemplary personification, it illustrates the view from a smart tablet or smartphone, similar to that of FIG. 3, after clicking on a body-camera/wearable recording device to enter it, on the screen, it depicts the status of the body-camera/wearable recording device, “power on”, the “battery percentage,” the wearer it is attached to during the operation/shift (666/Lewis), the “wakeup” icon that can be used to send a remote “wakeup command/power on” signal to said body-camera/wearable recording device if it is off and has some sort of battery power/trickle charge left, the “satellite” and “5G data” connection feature checked (for communication and data sync to the cloud), the icon to “stream” real-time footage of said wearer at the time, and the icon for a “map view” of the body-camera/wearable recording device(s), as illustrated in FIG. 4 and FIG. 5.

FIG. 10, in this exemplary personification, it illustrates an SMS message sent to a captain on their smartphone, from someone in the ops-center/dispatch urging them to view an active situation that may need their intervention. It includes the link/URL to a body-camera/wearable recording device, 666/Lewis, https://www.CamMfg/666/Lewis:50731. This type of message can be sent to a group so that if one person is not able to respond, another will. The person responding, the captain in this case can do so from their home, a vacation spot (beach, golf course, etc.), or while at dinner at a restaurant.

FIG. 11, in this exemplary personification, it illustrates the screen that opens after clicking on the URL/link in the SMS message from ops-center/dispatch: https://www.CamMfg/666/Lewis:50731. Presumably, the smart tablet or smartphone of someone viewing will be encrypted, so that the user will have to enter their credentials (AD/AAD account and password) before getting to this screen and launching the installed app via an icon, as illustrated in FIGS. 9, 10, 11, and 12. While viewing this screen for a body-camera/wearable recording device, a user will be able to click on the “stream” icon, it will lead to another screen such as depicted in FIG. 11 for a unique user pin. An added layer for security and audit purposes.

FIG. 12, in this exemplary personification, it illustrates the “live stream in progress” of an active situation from the body-camera/wearable recording device being worn by, 666/Lewis. Here the viewer will have the ability to speak and deliver audible voice commands to the wearer(s), presumably directing them to cease, standdown, or to change tactics. The viewer will also have the ability to mute their microphone on their smartphone/tablet with the icon “mute me” and solely view if they do not wish to convey anything, as in a SWAT or another tactical operation. The “map view” icon is there so that the viewer can see the geographic location of the active situation and the “send link” icon is also there for the viewer, so that if they need to send the link/URL to a particular body-camera/wearable recording device to someone else in charge or in the chain of command, etc.

### DETAILED DESCRIPTION OF THE INVENTION

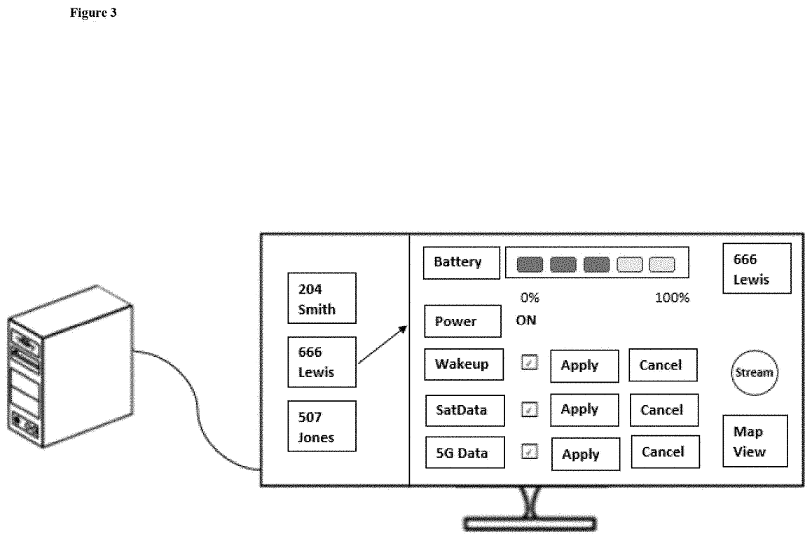

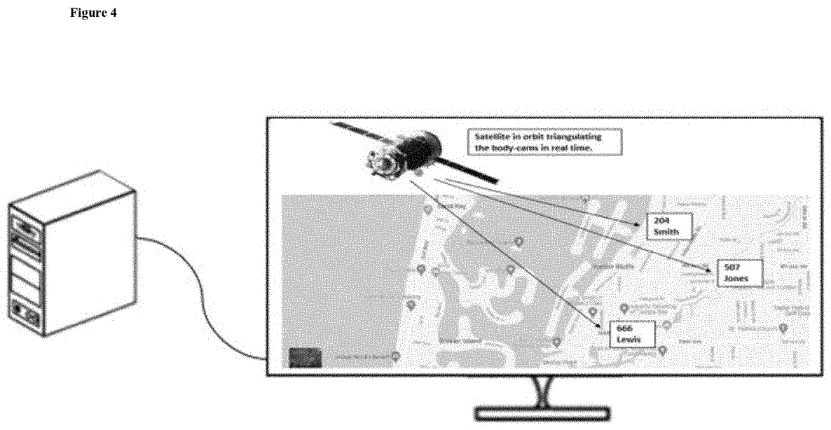

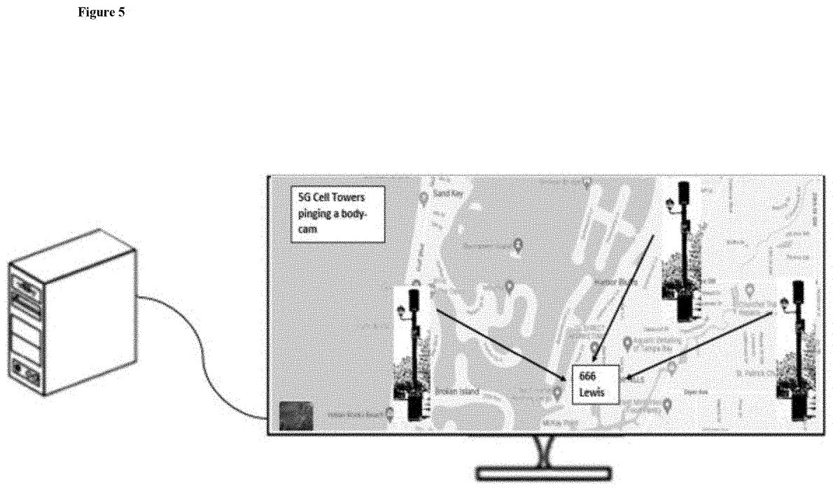

In the exemplary personification, a wearer at the beginning of a shift will assign themselves a wearable recording device and/or body-camera by scanning the barcode/QR-code on said body-camera/wearable recording device, with a barcode/QR-code laser scanner, this information will be correlated/parsed in a database with the wearer/device, pairing both for the duration of a shift, as depicted in the personification that are FIGS. 3, 4, 5, 6, 9, 11, and 12 (or the wearer can be paired with a body-camera/wearable recording device for the duration of their tenure).

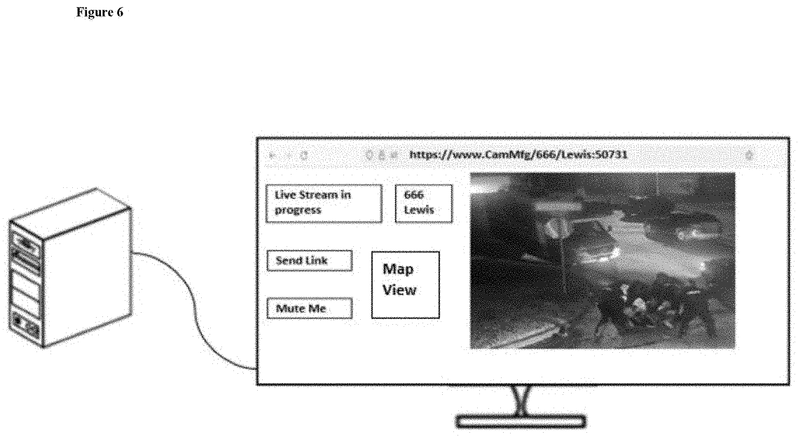

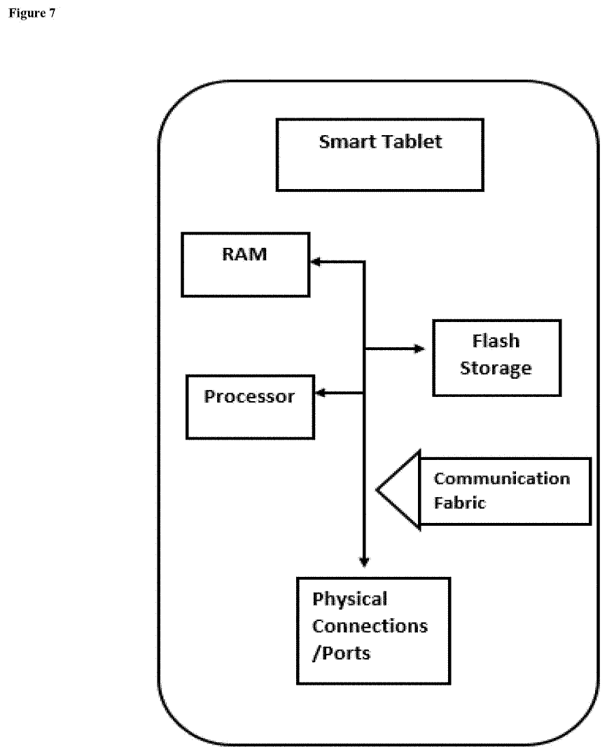

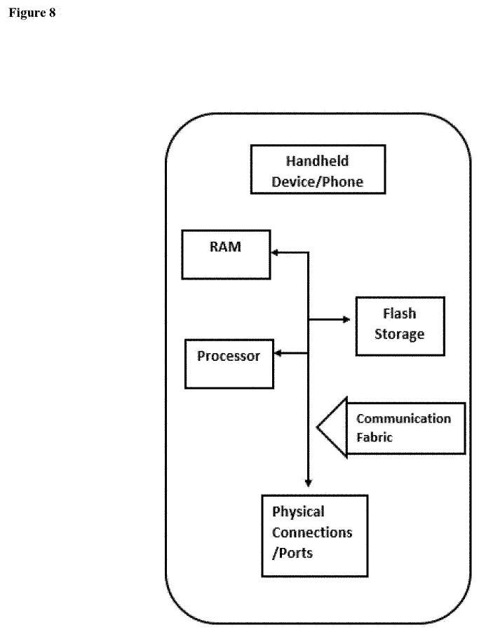

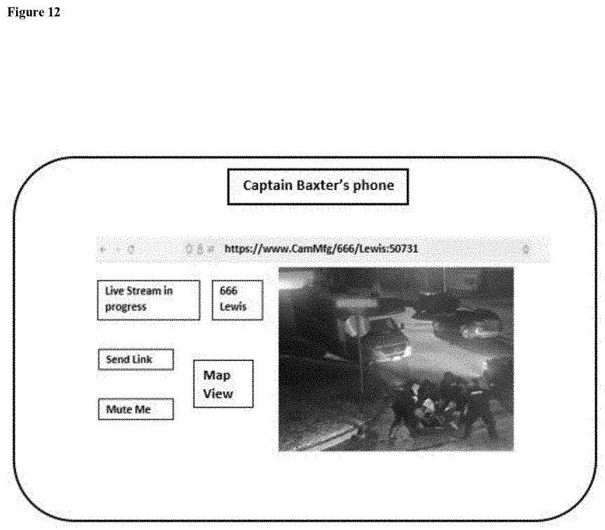

When a unit calls into the ops-center/dispatch, at this time someone can click on the wearer's body-camera/wearable recording device in the portal/website/installable app and start a live stream, observing and hearing everything as it happens. Subsequently, they can send the link of the live feed/stream through the portal and/or the installable app from their computer, said stream can be emailed to a supervisor so that they can watch in tandem or give commands to said wearer (refer to FIGS. 6 and 12). Subsequently, if the wearer initiates a recording on the body-camera/wearable recording device, it will mark them as unavailable in the map view, changing them to red, letting dispatch know that they are not available for a call, this too will occur when dispatch starts the live stream.

In universal terms, the OS of said body-camera(s)/wearable recording devices and other devices/computers/smartphones accessing this body-camera(s)/wearable recording devices will contain structured and un-structured code written in languages such as, but not limited to, ASPX, Microsoft.NET, XML, HTML, C++, C#, COBOL, CSS, PHP, Perl, Python, PowerShell Scripts, VBScripts, JAVA, APIs, and/or a variant thereof and/or any newer subsequent personifications to come or not listed herein. The hardware/systems of all said devices (“device(s)” herein 0025 is used universally) will contain, Flash Storage, RAM, System Boards, Processor chips, Satellite chips, GPS chips, 5G (newer subsequent personifications, 6G, 7G, etc.) Cellular chips, Bluetooth chips, Bluetooth Earbuds for pairing to said body-camera(s)/wearable recording devices, Graphics chips, BIOS/Firmware chips, Transistors, Capacitors, Transceivers, Receivers, Buttons, Keyboards, A.I. chips and non-A.I. chips, A.I. Code, Firmware chips, Lens, Optical Cameras, Barcode/QR-Code Laser Scanners, Batteries, Microphones, Speakers, USB Ports, Cables, CD/DVD ROMs, Databases, access to Cloud Storage (may even be ran in Cloud Storage), ran on VMs or non-VMs, LED/LCD Screens—touchscreen and non-touchscreen and/or a variant thereof.

The personification of the facial recognition portion, in the portal/installable app, there will be a field for an email distribution group, here it will contain a distribution group for everyone in dispatch, so that during a stop, if the body-camera/wearable recording device gets a hit of someone in a traffic stop, at a concert, a public event such as a state fair, it will automatically email out a picture/name of said suspect, cross-referenced to a crime database letting dispatch know. At which they can notify a wearer or they can let a supervisor know. The suspect can be engaged in real-time or watched/followed, etc.

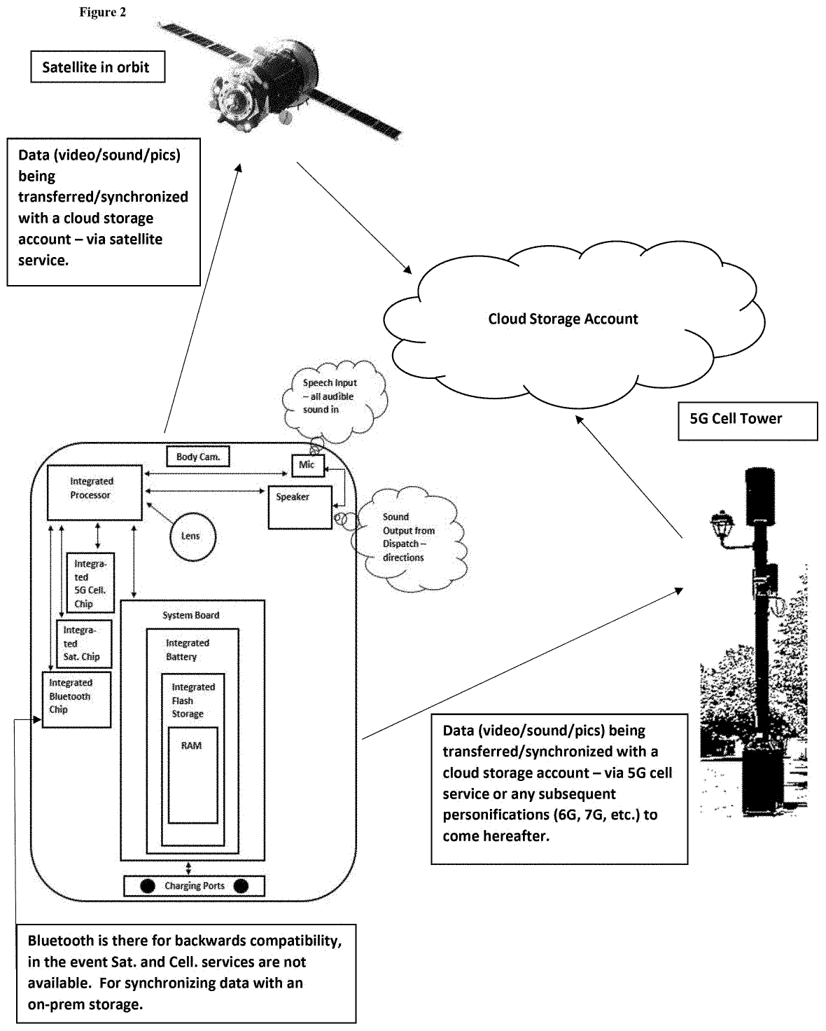

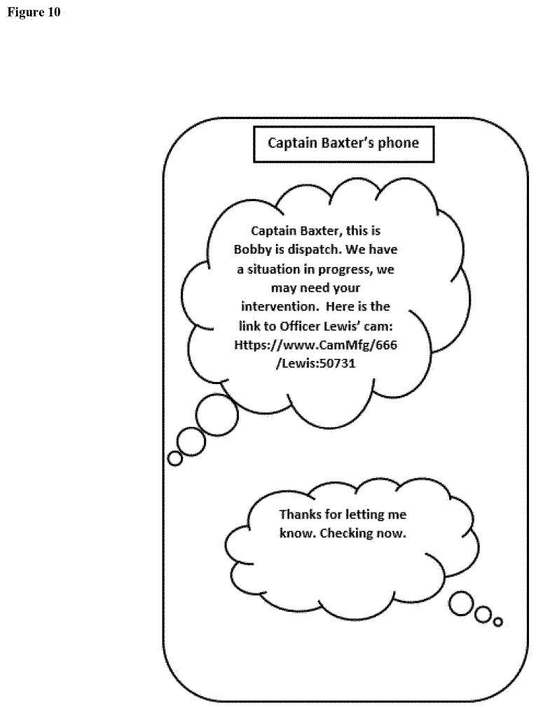

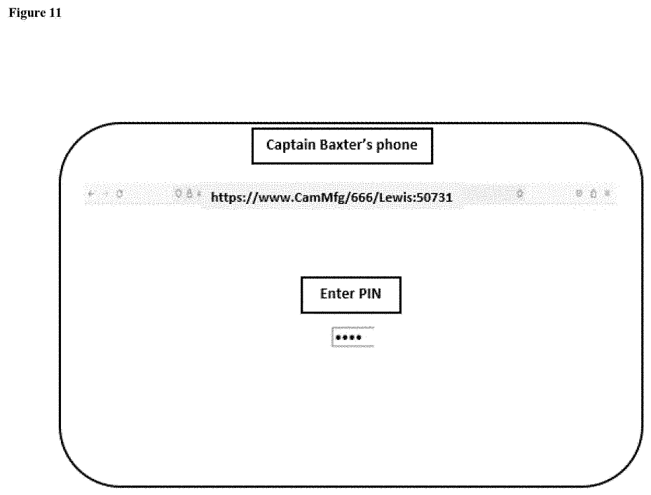

In additional personifications, this can be adapted for drones, drones that are not readily used yet, drones such as that for riot controls, drones used in instances to stop looting-sent into buildings, drones used for patrolling city streets where pole-mounted cameras cannot see, hostage situations, smaller drones with non-lethal rounds, smaller caliber rounds, and/or no weaponry. This will allow dispatch to speak to anyone, urging them to cease what they are doing, or to ask them to stop loitering and said subject can verbally exchange with dispatch/ops-center, etc. Moreover, in the case of a hostage situation, a mayor or any high valued stakeholder would be able to receive a link (refer to FIGS. 6 and 12), they will click on said link, they will enter a pin for a one-time use and be able to view an operation in real-time, all from the comfort of their home, on a vacation, etc. (refer to FIGS. 10 and 11), they can even communicate back to those in front of said drone/body-camera/recording device. Likewise, the camera software of said drone/body-camera/recording device will be equipped with facial recognition, the highlight boxes on the live feed/stream, for identifying a person, or a moving object can be edited out via A.I. code, as to not impede and/or obstruct the images and/or video quality. Similarly, the live feeds/streams from said drones/body-camera/recording devices would be synced to a cloud account as described herein, (refer to FIG. 2 for the flow of this data). A personification of a drone can be, a base-unit in size or proportion to a car, small car, a detachable portion from the base-unit that can hover and move freely, either attached via cables to said base or wirelessly (two-part drone), a drone that can be smaller than a car and has full autonomy (singular drone), even in a hive embodied form, and/or can be operated remotely by a person in a ops-center/dispatch. They can be represented in a human embodied form and/or animal, traditional triangular flying form, small aircraft form, circular form, rectangular form or a variant thereof.

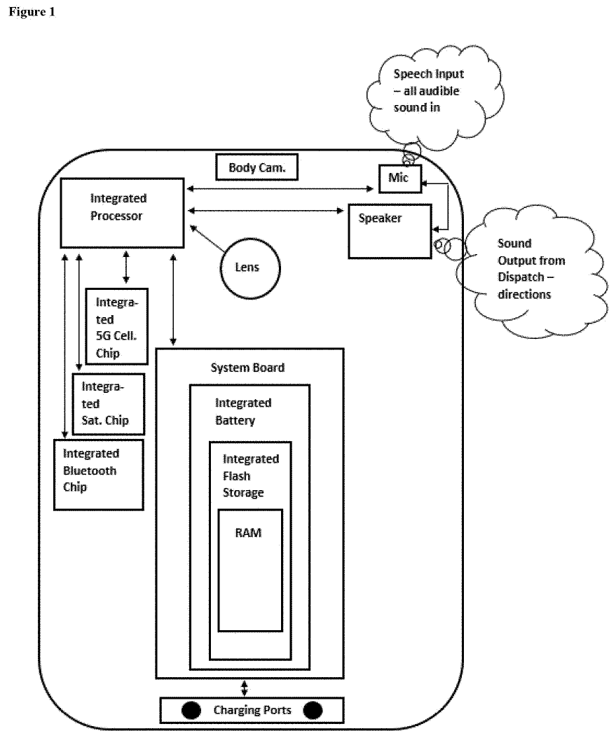

1. In this personification, the body-camera/wearable recording device herein, as embodied in FIG. 1, is equipped with an on-board integrated microphone that has the ability to process verbal input, transmitting it in real-time to the ops-center/dispatch, and the on-board integrated speaker has the ability to process verbal output in real-time from the ops-center/dispatch, in conjunction with real-time high-resolution video, allowing real-time two-way communication with the wearer, by way of the intermediary in an installable app and/or access to a website/portal, by way of a microphone on the ops-center/dispatch computer and/or mobile device (i.e., Smartphone, Tablet, etc.), (refer to FIGS. 1, 3, 6, and 12).

2. In this personification, as illustrated in FIG. 1, this body-camera/wearable recording device is equipped with an integrated satellite chip; an integrated 5G cellular chip (subsequent newer personifications hereafter may contain, 6G chip, 7G chip, 10G chip, etc.); the intent of said chips will allow real-time connections to be made with the body-camera(s)/wearable recording devices from ops-center/dispatch and/or leadership. Also, this will allow for near real-time synchronization of data to a cloud account, set to do so every 2 minutes, 5 minutes or 10 minutes (or any other values deemed fit by leadership), as personified in FIG. 2; within minutes of the recordings being captured it could be accessed in the cloud storage account by those with rights to said account (access can be made via a Laptop/Desktop Computer, Smartphone, or Tablet). A primary method of connection to the cloud can be set and a secondary method if the primary method is not available (such as in inclement weather for satellite connections), or both can be checked at the same time so that the body-camera/wearable recording device will compensate automatically, as personified in FIGS. 2, 3, 4, 5, and 9. An integrated Bluetooth chip for backwards compatibility, if in the event satellite and/or cellular services are not available, as personified in FIG. 1. The Bluetooth chip, will allow someone to synchronize the data to an on-prem storage once in range. Finally, a wired/USB connection to the charging port(s) at the base can allow for data to be extracted, in the event of excessive/extreme physical damage to said body-camera/wearable recording device, as personified in FIG. 1.

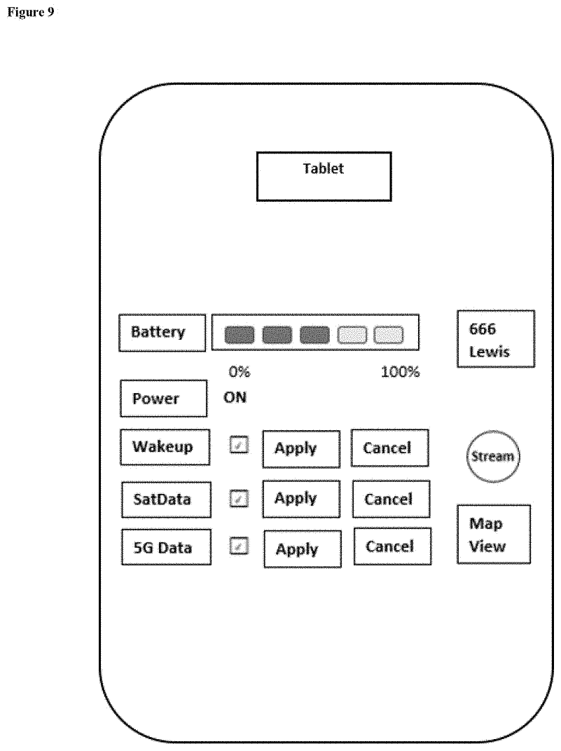

3. In this personification, the remote “wakeup/power on” feature is similar to that of the “wake-on-LAN” feature that is used for network interface cards (NICs), used in physical server(s) hardware since the 90's. In this personification, as long as there is a trickle charge from the integrated battery, the body-camera/wearable recording device can be sent a remote wakeup signal, if for any reason it is turned off, (refer to FIGS. 3 and 9). In this personification, it is a secondary reason why the battery charge percentage feature is there in the website/portal/installable app, (refer to FIGS. 3 and 9). If there is a trickle charge from the battery, it will allow those in dispatch to triangulate the body-camera/wearable recording device, via the “map view” icon, (refer to FIGS. 3, 4, 5 and 9).

4. Facial recognition capabilities are widely available in an array of cameras used for surveillance, both in public purview and within establishments for the sake of conducting business, this personification can utilize it as well. In this personification, it will provide real-time facial recognition and cross-reference those images with crime databases, which can be monitored by those in the ops-center/dispatch on large screens during stops and/or interactions with said wearer. This will allow for an added layer of scrutiny, considering the fact that a wearer is not able to focus on detailed assessments during a traffic stop, due to external factors or heightened stresses. This technology can see past beards, makeup, hair styles, hyaluronic injectables, and/or any other attempts at a disguise. By the time a wearer gets an ID, walks back to the mobile-squad-unit to run said ID, the software in this personification would have run the checks on the bystander's face, ops-center/dispatch can let the wearer know of any potential dangers and potentially have backup units in route all before an ID is ran. This will also minimize most potentiality of mistaken identity in an arrest/apprehension. This will be integral in traffic stop situations, out-door and in-door venues with large crowds (concerts, fairs, car shows, etc.), in an event of a large riot and the like. Not only can the facial recognition component be used to identify/cross-reference people's faces in crime databases, any images from a crime scene of on outstanding cases can be cross-referenced to said databases while the wearer(s) is in the public purview, i.e., license plates, bags with specific patches/insignias, clothing with unique branding/insignias, unique jewelry, etc., in so doing, potentially getting hits on an artifact specific/unique to an open case and/or leading to back to a potential perpetrator. Additionally, there will be a public facing website for the general public meant for the sake of petitioning governing bodies to have said identity(s) remove from said crime databases, in the instances of a person's likeness is accidently uploaded to a crime database. There will be rare instances where an innocent person's image/likeness will be uploaded to a crime database and petitioning the governing bodies/entities to have it removed will be a safeguard from potential abuse, three or more governing bodies/entities will be involved in the vetting of said person(s) to ensure that they are in fact law abiding and not wanted for any crimes.

5. In this personification, the technologies herein can be adapted for drones (as it relates to claims 1, 2, 3, and 4), drones that are not readily used yet, drones such as that for riot controls, drones used in instances to stop looting-sent into buildings, drones used for patrolling city streets where pole-mounted cameras cannot see, hostage situations, smaller drones with non-lethal rounds, smaller caliber lethal rounds, and/or no weaponry. This will allow dispatch to speak to anyone, urging them to cease what they are doing, or to ask them to stop loitering and said subject can verbally exchange with dispatch/ops-center, etc. Moreover, in the case of a hostage situation, a mayor or any high valued stakeholder would be able to receive a link (refer to FIGS. 6 and 12), they will click on said link, they will enter a pin for a one-time use and be able to view an operation in real-time, all from the comfort of their home, on a vacation, etc. (refer to FIGS. 10 and 11), they can even communicate back to those in front of said drone/body-camera/recording device. Likewise, the camera software of said drone/body-camera/recording device will be equipped with facial recognition, the highlight boxes on the live feed/stream, for identifying a person or a moving object can be edited out via A.I. code, as to not impede and/or obstruct the images and/or video quality. Similarly, the live feeds/streams from said drones/body-camera/recording devices would be synced to a cloud account as described herein, (refer to FIG. 2 for the flow of this data). The personification of the drone(s) can be, a base-unit in size or proportion to a car, small car, a detachable portion from the base-unit that can hover and move freely, either attached via cables to said base or wirelessly (two-part drone), a drone that can be smaller than a car and has full autonomy (singular drone), even in a hive embodied form, and/or can be operated remotely by a person in a ops-center/dispatch. They can be represented in a human embodied form and/or animal, traditional triangular flying form, small aircraft form, circular form, rectangular form or a variant thereof. A drone(s) propelled by jet engine(s) (a drone with one, two, three, four, five, and/or six jet engines, and/or a variant thereof), a rotary type motor(s) with propellers) (a drone with one, two, three, four, five, and/or six rotary type motor(s) with propellers, and/or a variant thereof).
